(19) United States
(12) Patent Application Publication
(10) Pub. No.: US 2016/0057733 A1
(43) Pub. Date: Feb. 25, 2016

(54) SYSTEMS AND METHODS FOR USING GRAPH MODELING TO MANAGE, MONITOR, AND CONTROL BROADCAST AND MULTIMEDIA SYSTEMS

(71) Applicant: Grass Valley USA, LLC, Burbank, CA (US)

(72) Inventors: Roberto Grandillo, St-Jean-Sur-Richelieu (CA); Mario Cormier, Laval (CA)

(21) Appl. No.: 14/832,848

(22) Filed: Aug. 21, 2015

Related U.S. Application Data
(60) Provisional application No. 62/040,786, filed on Aug. 22, 2014.

(51) Int. Cl. H04W 72/00; H04L 12/26; H04L 12/727; H04L 12/721; H04H 20/42; H04W 40/04

(52) U.S. Cl. CPC H04W 72/005; H04H 20/423; H04W 40/04; H04L 45/121; H04L 45/124; H04L 43/0858

(57) ABSTRACT

The present disclosure describes systems and methods for dynamic graph-based modeling and analysis system for broadcast environments. The graph model provides index-free adjacency for relationships between nodes, unlike relational databases, and is ideal for large volume, highly variable, semi structured and densely connected data. In particular, and unlike other graph-based modeling systems, the systems and methods discussed herein provide a modeling system that is aware of signal flow between components and through the graph model, from sources through processing and routing to destinations. Simultaneously, the system may be aware of signal types and formats and can enforce interconnection rules. The system may also execute in real-time, to provide dynamic and frame-accurate control of multiple routers throughout the broadcast environment.

### RELATED APPLICATIONS

The present application claims the benefit of and priority to U.S. Provisional Application No. 62/040,786, entitled “Systems and Methods for Using Graph Modeling to Manage, Monitor, and Control Broadcast and Multimedia Systems,” filed Aug. 22, 2014, the entirety of which is hereby incorporated by reference.

### FIELD

The present application relates to systems and methods for broadcast environment management. In one aspect, the present application is directed to a dynamic graph-based modeling, analysis, monitoring, and control system for broadcast environments.

### BACKGROUND

Typical broadcast environments, such as television or radio studios or related production environments, may include hundreds of discrete media sources and destinations and thousands of potential signal paths. For example, a small television news studio may include three cameras, each with high definition and standard definition video output feeds, return video monitor feeds, and audio feeds to and from camera operator headsets; in-studio monitors and teleprompters; several lapel microphones and/or boom microphones; in-ear audio monitors for cueing purposes or for communicating from a producer to anchors; audio and video playback systems for pre-recorded segments; remote communications systems for on-location or live remote feeds; audio mixing consoles; video switchers and routers; satellite uplink transmitters; connections to terrestrial transmitters; or many other such devices, and literally miles of wiring. As studios increase in size, the number of devices and interconnections can grow exponentially.

Designing and maintaining broadcast environments requires in-depth understanding of the signal paths between each device. As result, engineers typically create large system diagrams to illustrate each physical interconnection connection; wire lists identifying each wire in the system by source, destination, type, length, etc.; and multiple signal flow diagrams illustrating typical set-ups (e.g. live in-studio broadcast; broadcast with one remote site; broadcast with two remote sites; pre-recorded interview; etc.). These system diagrams may be complex and non-intuitive, difficult and expensive to create and maintain particularly as components are upgraded or replaced, and may not be useful for troubleshooting or creating new system configurations.

### SUMMARY

The present disclosure describes systems and methods for dynamic graph-based modeling and analysis system for broadcast environments. The graph model provides index-free adjacency for relationships between nodes, unlike relational databases, and is ideal for large volume, highly variable, semi structured and densely connected data. In particular, and unlike other graph-based modeling systems, the systems and methods discussed herein provide a modeling system that is aware of signal flow between components and through the graph model, from sources (e.g. cameras, microphones, digital playback systems, satellite receivers, etc.) through processing and routing to destinations (e.g. recording devices, transmitters, network connections, etc.). Additionally, the system may be aware of signal types and formats and can enforce interconnection rules (e.g. HD video outputs connect to HD video inputs, stereo audio outputs connect to stereo audio inputs, feedback loop elimination, etc.). The system may also execute in real-time, to provide dynamic and frame-accurate control of multiple routers throughout the broadcast environment.

In one aspect, the present disclosure is directed to a method of managing broadcast resources via a graph-based model. The method includes identifying, by a management system of a broadcast environment, characteristics of each of a plurality of broadcast resources, the characteristics including at least an input or output. The method also includes generating, by the management system, a graph-based model of the plurality of broadcast resources based on the identified characteristics. The method further includes receiving, by the management system, a request to route a signal from a first broadcast resource of the plurality of broadcast resources to a second broadcast resource of the plurality of resource. The method also includes selecting, by the management system, a path from the first broadcast resource to the second broadcast resource via at least one additional broadcast resource, based on the identified characteristics of each of the plurality of broadcast resources; and commanding, by the management system, the first broadcast resource, second broadcast resource, and at least one additional broadcast resource to send and receive signals along the selected path.

In some implementations, the characteristics further include at least one input signal type and at least one output signal type. In a further implementation, the first broadcast resource has a first signal type, the second broadcast resource has a second signal type, and selecting the path from the first broadcast resource to the second broadcast resource further includes selecting a path via a third broadcast resource having an input signal type of the first signal type and an output signal type of the second signal type.

In other implementations, selecting the path from the first broadcast resource to the second broadcast resource further includes identifying a shortest path via the graph-based model. In a further implementation, the method includes identifying a path from the first broadcast resource to the second broadcast resource via a fewest number of intermediary nodes of the graph, each node representing a broadcast resource. In another further implementation, the method includes identifying a path from the first broadcast resource to the second broadcast resource having a lowest total latency, each broadcast resource of the graph having an associated processing latency.

In still other implementations, the selected path from the first broadcast resource to the second broadcast resource is via a third broadcast resource, and the method includes receiving, by the management system, a request to route a signal from a fourth broadcast resource to a fifth broadcast resource; selecting, by the management system, a path from the fourth broadcast resource to the fifth broadcast resource via the third broadcast resource; determining, by the management system, the third broadcast resource is unable to simultaneously carry the path between the first and second broadcast resources and the path between the fourth and fifth broadcast resources; selecting, by the management system, a second path from the first broadcast resource to the second broadcast resource via a sixth broadcast resource; and commanding the first broadcast resource, second broadcast resource, and sixth broadcast resource to send and receive signals along the second path. In a further implementation, the method includes identifying a first cost of the path from the first broadcast resource to the second broadcast resource via the third broadcast resource; identifying a second cost of the path from the fourth broadcast resource to the fifth broadcast resource via the third broadcast resource; determining that the first cost exceeds the second cost; and selecting the second path, responsive to the determination that the first cost exceeds the second cost. In a still further implementation, the method includes identifying a third cost of the path from the first broadcast resource to the second broadcast resource via the sixth broadcast resource; identifying a fourth cost of a path from the fourth broadcast resource to the fifth broadcast resource via a seventh broadcast resource; determining that the third cost is less than the fourth cost; and selecting the second path responsive to the determination that the third cost is less than the fourth cost. In a yet still further implementation, the method includes determining that a difference between the third cost and first cost is less than a difference between the fourth cost and second cost; and selecting the second path responsive to the determination that the difference between the third cost and first cost is less than the difference between the fourth cost and second cost. In another further implementation, identifying a first cost of the path from the first broadcast resource to the second broadcast resource via the third broadcast resource further includes identifying a total length of the path, a total latency of the path, a number of resources traversed by the path, a number of unique resources traversed by the path, or a number of alternate paths available.

In another aspect, the present disclosure is directed to a system for managing broadcast resources via a graph-based model. The system includes a processor executing a management agent in communication with at least one of a plurality of broadcast resources via a network interface of the system. The management agent is configured to identify characteristics of each of a plurality of broadcast resources, the characteristics including at least an input or output; and generate a graph-based model of the plurality of broadcast resources based on the identified characteristics. The management agent is also configured to receive a request to route a signal from a first broadcast resource of the plurality of broadcast resources to a second broadcast resource of the plurality of resource. The management agent is also configured to select a path from the first broadcast resource to the second broadcast resource via at least one additional broadcast resource, based on the identified characteristics of each of the plurality of broadcast resources, and command the first broadcast resource, second broadcast resource, and at least one additional broadcast resource to send and receive signals along the selected path.

In some implementations, the characteristics identify an input signal type and an output signal type, the first broadcast resource has a first signal type, the second broadcast resource has a second signal type, and the management agent is further configured to select a path via a third broadcast resource having an input signal type of the first signal type and an output signal type of the second signal type. In other implementations, the management agent is further configured to identify a shortest path via the graph-based model, and select the shortest path as the path from the first broadcast resource to the second broadcast resource. In a further implementation, the management agent is further configured to identify a path from the first broadcast resource to the second broadcast resource via a fewest number of intermediary nodes of the graph, each node representing a broadcast resource, or having a lowest latency.

In some implementations, the selected path from the first broadcast resource to the second broadcast resource is via a third broadcast resource; and the management agent is further configured to select a second path from the first broadcast resource to the second broadcast resource via a fourth broadcast resource, responsive to a determination to use the third broadcast resource for a third path between additional broadcast resources; and command the first broadcast resource, second broadcast resource, and fourth broadcast resource to send and receive signals along the second path. In a further implementation, the management agent is further configured to identify a first cost of the path from the first broadcast resource to the second broadcast resource via the third broadcast resource, and select the second path responsive to the first cost exceeding a cost of the third path. In another further implementation, the management agent is further configured to increase the first cost responsive to the first broadcast resource and second broadcast resource less than all of the functions of the third broadcast resource. In still another further implementation, the management agent is further configured to identify the first cost based on a total length of the path or a total latency of the path. In yet still another further implementation, the management agent is further configured to identify the first cost based on a number of resources traversed by the path, a number of unique resources traversed by the path, or a number of alternate paths available.

### BRIEF DESCRIPTION OF THE FIGURES

FIGS. 1A-1B are graph diagrams of exemplary embodiments of a template for a broadcast environment, and an environment using such a template, respectively;

FIG. 1C is another graph diagram of an exemplary embodiment of a template for a broadcast environment;

FIG. 2 is a schema diagram of an example embodiment of a graph-based model for a broadcast environment;

FIG. 3A is a block diagram of an exemplary system for generating, analyzing, and maintaining graph-based models for broadcast environments;

FIGS. 3B and 3C are left and right halves, respectively, of an exemplary screenshot of a graph editing interface;

FIGS. 3D and 3E are left and right halves, respectively, of another exemplary screenshot of a graph editing interface in a real-time view;

FIGS. 4A and 4B are flow charts of implementations of methods of using graph modeling to manage, monitor, and control a broadcast environment; and

FIG. 5 is a block diagram of an exemplary computing device useful for practicing the methods and systems described herein.

In the drawings, like reference numbers generally indicate identical, functionally similar, and/or structurally similar elements.

### DETAILED DESCRIPTION

The following description in conjunction with the above-reference drawings sets forth a variety of embodiments for exemplary purposes, which are in no way intended to limit the scope of the described methods or systems. Those having skill in the relevant art can modify the described methods and systems in various ways without departing from the broadest scope of the described methods and systems. Thus, the scope of the methods and systems described herein should not be limited by any of the exemplary embodiments and should be defined in accordance with the accompanying claims and their equivalents.

The present disclosure describes systems and methods for dynamic graph-based modeling and analysis system for broadcast environments, and describes a modeling system that is aware of signal flow between components and through the graph model, from sources (e.g. cameras, microphones, digital playback systems, satellite receivers, etc.) through processing and routing to destinations (e.g. recording devices, transmitters, network connections, etc.). Simultaneously, the system may be aware of signal types and formats and can enforce interconnection rules (e.g. HD video outputs connect to HD video inputs, stereo audio outputs connect to stereo audio inputs, feedback loop elimination, etc.). The system may also execute in real-time, to provide dynamic and frame-accurate control of multiple routers throughout the broadcast environment.

The graph model provides flexibility, since vertices and edges can have multiple key-value pairs and documents. Vertices and edges can also use object modelling to support inheritance, constraints, reusability, sub-classing, convenience and other benefits of object oriented modelling. In some implementations, the graph model may be generated via a NoSQL database system, relational database management system, a graph database system, or any other type and form of database system. The database system may identify objects, classes, and clusters of classes and/or objects.

The graph may be analysed by the system with flexible queries in real-time, including:
What is the shortest, cheapest path between source A and destination B?
What path should I use to switch a source signal in a 720p60 format to a 1080i30 destination?
How do I use the resources to perform shuffling of 16 tracks of audio across multiple video signals using a hybrid router?
How do I perform a multi-hop tie-line take involving 5 routers in less than a second?
What are the paths that are most used and busy?
Can I create complex business rules to do automatic, predictable control in a signal path?
What is the root cause of this failure?
What are the related alarms in the system and which ones should I be focusing on resolving?
What happens if I remove this device in the system?
What do I need to do to support adding new HD channels?
What was the status of the signal path and all devices 2 weeks ago when we missed airing an ad?
   Accordingly, implementations of the graph model opens up many other possibilities to perform advanced graph analytics and create extensive reports and metrics on historical data.

In some implementations, the graph model may comprise one or more vertices V, connected by one or more edges E. Each vertex V and edge E may include one or more key properties or parameter-value pairs, which may be extensibly defined. As discussed in more detail below, the graph model may be modeled and used at the application level with an interface provided by a dedicated application, a web browser, or other such application. Accordingly, the graph model does not require complex additional layers to map relational data to objects with relationships, allowing much faster development and reduction of maintenance.

The model may also be extended and new objects may be included in the model without changing code. For example, new products and devices may be added to the model easily using existing templates identifying ports and signal types, without needing to create detailed records for each object. In some implementations, the graph model may be dynamically loaded as necessary, providing memory-efficient and quick access, even on limited systems, or providing granularity for efficient queries, even with large databases.

In many implementations, the graph model may represent the static state of the system, and may be generated by a user or engineer using templates in various sizes from a single vertex to an entire device comprising a plurality of vertices and edge interconnections. In some implementations, templates may be even larger for a typical signal path (e.g. microphone to pre-amplifier to signal processor to analog to digital converter, each comprising at least vertices for inputs and outputs with edge interconnections within each device and between devices). Instances of the graph may also show changes over time or as a signal flows through the broadcast environment, and accordingly, the model may have multiple dimensions.

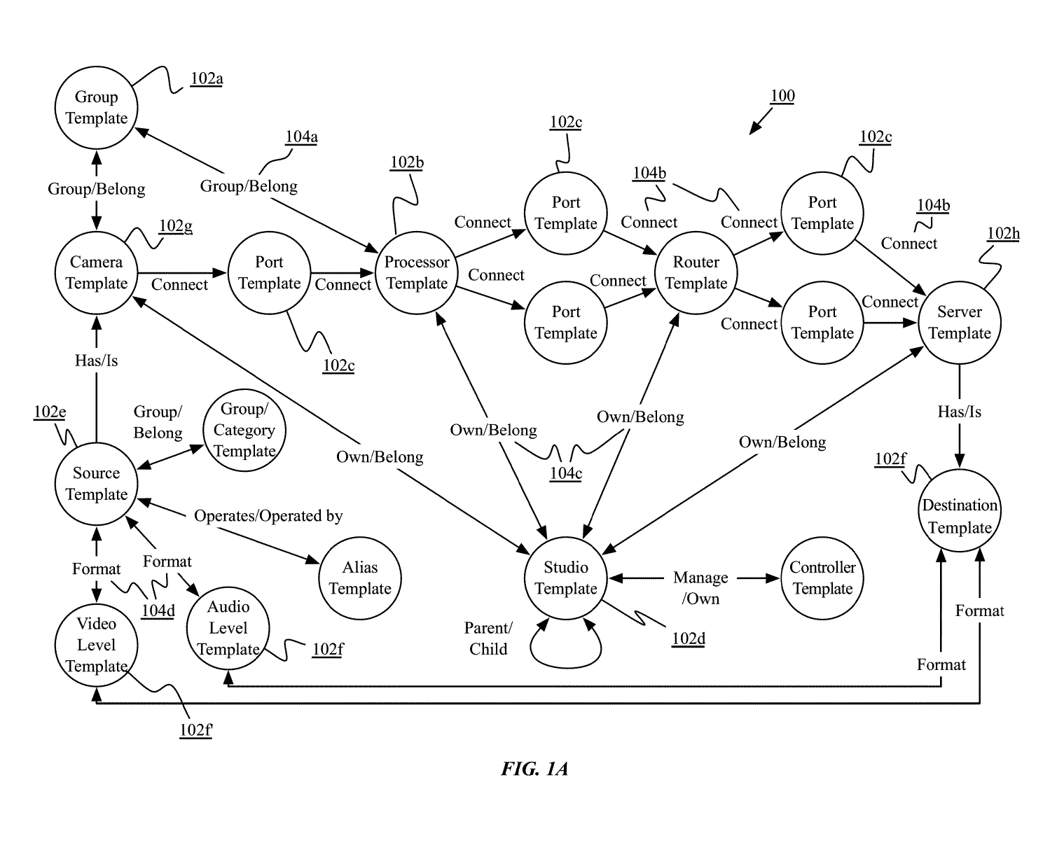

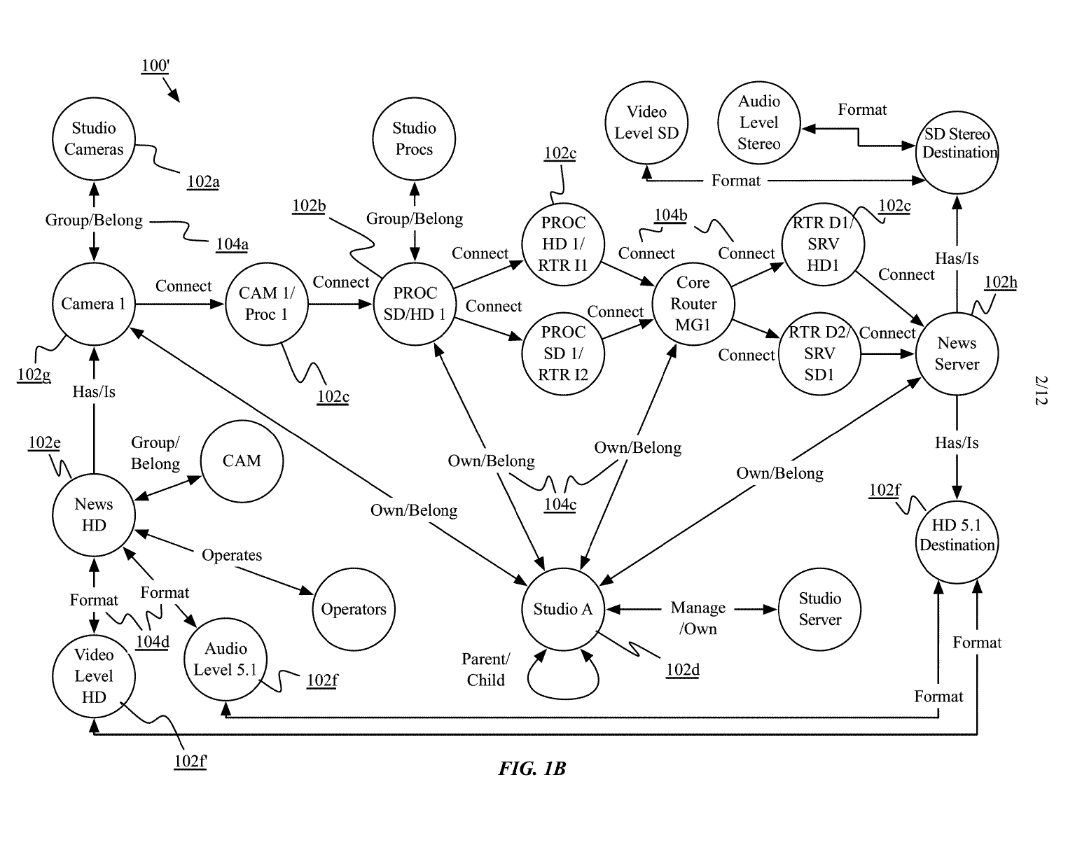

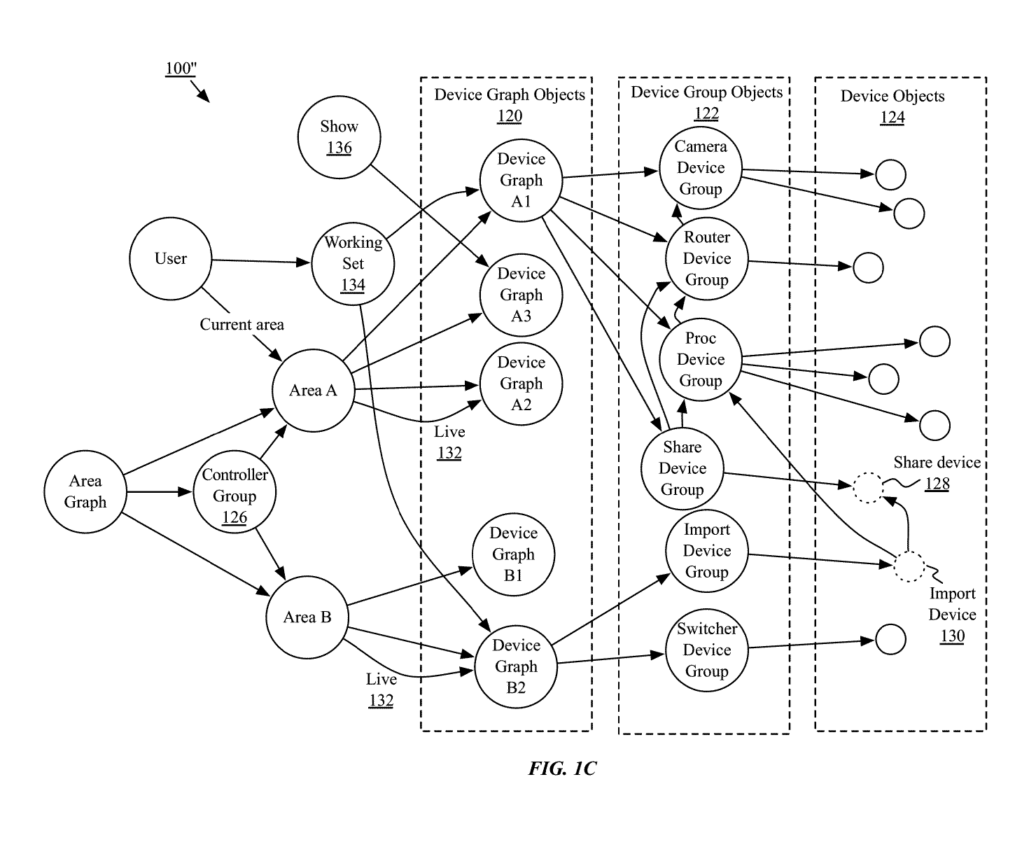

Referring first to FIG. 1A, illustrated is a graph diagram of an exemplary template for a typical small broadcast environment. Although shown in a freeform format, in some implementations, applications or viewers may display the graph in an orthogonal or radial format. Custom properties of each node 102 and edge 104 are not shown on the graph for clarity, but may be linked to each node 102 and edge 104 and may include records of multiple types including plain values, key-value or parameter-value pairs, alphanumeric strings, predetermined types or ranges, documents or embedded documents, or any other type and format of data, as well as complex data types such as lists, maps, collections, etc. Nodes 102 may also be grouped into sub-classes. For example, a camera, processor, router, and server may all be identified as part of the class “devices” and inherit properties common to all “devices” (e.g. include at least one port vertex, etc.). In another example, a studio vertex 102d may be identified as part of the class “area”, and accordingly may include at least one device vertex (e.g. “camera template”, “controller template”, “processor template” 102b, etc.). Similarly, edges 104 may be grouped into classes, such as classes for signal types or formats 104d (standard definition video, 720p60 video, 1080i50 video, etc.), interconnection type (e.g. analog audio over copper, digital audio over copper such as audio in the Audio Engineering Society (AES) format, digital video over fiber, Serial Digital Interface (SDI) interconnections, internet protocol (IP) or other packetized connections, or any other type and form of interconnections, as discussed below), or any other such class. In some embodiments, class and property inheritances can be hierarchical with multiple levels.

Still referring to FIG. 1A and in more detail, nodes may be reused throughout the graph 100 and may be assigned unique identifiers. For example, each device (e.g. cameras, processors, routers, servers, etc.) may connect via an edge (e.g. “connect” edge 104b) to a port template 102c. Accordingly and as shown, the graph 100 may include a plurality of port templates 102c and corresponding connect edges 102c. As discussed above, devices may belong to groups 102a. In some implementations, groups may be drawn as areas within the graph, while in other implementations and as shown, groups may comprise nodes (e.g. group template 102a) to which devices belong by being connected via “belong” edges 104a. Similarly, devices may belong to an area (e.g. studio node 102d) by being connected via ownership edges 104c. An area may comprise a container for resources, and group together things that are closely related, often because of physical location but also because of functionality, ownership or logical organization. An area may be managed by a controller group, meaning that all resources in the area are managed by a single cluster of controllers collaborating closely.

A resource may comprise an entity that is managed by an area. Resources may include devices, users, and device graphs. For instance, referring briefly to FIG. 1C, illustrated is another example of a graph 100″ illustrating management of entities via groups. In the example shown, Area B owns the User, device graphs B1 and B2 and all the device groups and devices these graphs reference. A device graph object 120, such as device graphs B1 and B2 or A1-A3, represents a configuration defined by the system, and includes device groups 122 and their interconnections, which in turn contain device instances 124, their input and output physical ports and their interconnections as shown in FIGS. 1A-1B. Devices may be grouped in device groups 122, which may comprise one or more devices 124. Similarly, a controller group 126 may comprise a group of one or more controllers (e.g. physical or virtual servers, system controllers, automation systems, etc.). In some implementations, devices in a device group and/or controllers in a controller group may be load balanced or used as hot backups in case of failure to provide redundancy.

A share device 128 may comprise a pseudo-device or virtual device used to make signals available to downstream areas. A share template may be a device template that can be used to create a device group 122 containing a single share “device” 128. Outputs from device groups 122 in a device graph can be connected to the share device group, which may include inputs in the device graph. Each such connection may result in an import template becoming available in other areas.

Similarly, an importer 130 is a pseudo-device or virtual device that is used to receive signals from upstream areas. Importers 130 may be created via import templates, and may maintain two essential elements of information: the upstream device group that the importer 130 is importing, and the share 128 through which it is importing it. The import template in an area shows device groups 122 that have been shared in other areas. The import template can be dropped into the device graph to create an importer instance 130. The import template may include two essential elements of information: the share object 128 and the shared device group (because multiple device groups can be connected to a share, resulting in multiple import templates). In the exemplary embodiment shown in FIG. 1C, the share device 128 may result in two import templates because it links to two upstream device groups 122, the “Router” and “Proc” device groups.

As shown in FIG. 1C, in many implementations, each area may have one device graph defined as the “live” graph 132. The live graph may comprise the configuration that the area's controller group is currently implementing or realizing by controlling various switchers and routers. Devices may be considered live if they are being referred to by a device graph that is currently live.

A working set 134 represents a possible system configuration that may be the current live configuration, an offline configuration, working copies, versioned copies, or a combination thereof. The working set 134 comprises one or more device graphs, including one device graph per area in the current area graph. The working set 134 may comprise a list or data table including a combination of explicit direct links to one or more device graphs, and the currently live 132 device graphs for those that are not specified. The working set 134 provides a context to evaluate the validity and consistency of the possible system configuration that it defines. In some implementations, the working set 134 may allow a certain level of “what if” scenario evaluation by allowing virtual rerouting and analysis of graph deployments. In some implementations, a working set 134 may be saved by name to a storage library for later recall, and may be referred to as a show 136. The show 136 is not associated with a specific user, unlike a typical working set 134, and may be accessible to any user upon recall. During recall, any explicit device graph links may become live 132 if they are not already; remaining areas with unspecified device graphs may be left untouched. The show 136 configuration can also include various settings and actions that need to be applied or triggered when the show goes live (e.g. “recall user profile #2 on this processor”, “activate router salvo #1”, “load layout A on a multi-viewer”, etc.). Being that a show 136 is in itself a working set 134, it may be possible to evaluate the consistency of the show's configuration at any time, including analyzing the effect of implementing the show as a live set just prior to actually triggering any switching or commands.

In some implementations, an administrator may create a graph such as the one shown in FIG. 1C by selecting an area graph containing a controller group, one or more areas, and a user. The administrator may then edit a device graph (e.g. device graph A1 for area A) by adding a few interconnected device groups (e.g. 2 cameras, 1 router, 3 processors, as shown). The administrator may add a share device group, which will automatically create the share device 128. The administrator may connect the share group to the router and processor device groups. This will cause the system to automatically create two corresponding import templates for a router from area A and a processor from area A in area B. The administrator may switch to area B and edit a device graph (e.g. device graph B2) to add a switcher device group. The administrator may then use an import template to add a processor from area A to area B, causing the system to create the importer device instance 130. The switcher from area B may then be connected to the processor from the area A device group.

In some implementations, different areas sharing signals may be managed by different controllers. Accordingly, to allow the use of import templates from other areas, links from importer device instances 130 may be treated as remote links rather than local edges within the topology.

Returning to FIG. 1A, as shown, the graph 100 may illustrate potential paths for a signal flow from a source to a destination. Sources and destinations may both be devices and accordingly may be nodes (e.g. a “camera template” node 102g connected to a source template 102e node via an “is” edge; or a “server template” node 102h connected to a destination template 102f via an “is” edge). Users can intuitively follow signal flow from the source node to destination node, and the system can dynamically identify shortest paths, route around failed devices, identify common properties between devices such as ownership, format type, connection type, etc. or perform any other such features.

Each template node within the graph may represent an entity type, such as a device, port, source, destination, signal processor, media source, user or operator, physical or virtual area, or any other type and form of device. These templates may be combined to create end-to-end path templates representing the logical or physical infrastructure of the broadcast environment. Other data constructs, templates, and properties may be added to the graph to group, tag, and organize entities within a logical structure. For example, tag objects may comprise metadata created by users or administrators for easy searching of the graph, and may be linked to entity objects.

Signal flow from node to node may be via various types of interconnections, including SDI interconnections, such as the 259M standard promulgated by the Society of Motion Picture and Television Engineers (SMPTE) or the SMPTE 372M dual link interconnection format, or any other type of serial or parallel format. Such formats may include ancillary data channels, in addition to audio and/or video. In other implementations, signal flow may be via a packetized protocol, such as IP data via twisted-pair cables (e.g. 1000BASET Ethernet), optical fiber, or any other type and form of physical interconnection. In some such implementations, switches or routers may be included as nodes within the graph, while in other implementations, switches or routers may be considered part of the physical layer separate from the signal flow-based graph model. Such interconnection types can provide dynamic rerouting functionality to the system, as well as providing remote interconnection via virtual private networks over wide area networks, etc.

FIG. 1B is an illustration of an example graph 100′ displaying an instance of the system of FIG. 1A, with specific devices and nodes identified. As shown, a camera 102g may be a member of the “news HD” class 102e (shown by the “is” edge connection), and may accordingly inherit all of the properties of the class 102e, including belonging to the camera (CAM) class of devices, being operated by a user or “operator”, and inheriting various audio and video formats and levels 102f, 102f′. Similarly, the camera 102g may also belong to the “studio cameras” group 102a (shown by the “belong” edge connection 104a). The camera 102g may connect to, or more frequently have, an internal port 102c, which may be connected to a processor that belongs to the studio processors group. Output ports 102c of the processor may be connected to a core router, which itself may connect to ports 102c of a news server 102h, which may be both a high definition (HD) 5.1 destination 102f and a standard definition (SD) stereo destination. Other sources and destinations not illustrated may include servers, workstations, desktop machines, or modular systems, such as blade servers, or chassis or frame mounted systems on cards, card based playout devices, or any other type and form of source or destination. In many implementations, each instance of the graph 100, 100′ may have a single source (e.g. camera 1 102g connected to a source template 102e) and may have one or more destinations. Signal flow may be quickly visualized as a flow across the graph from a source to a destination.

Accordingly, via the graph 100′, complex analyses may be performed quickly by traversing the graph, such as “who are the operators of CAM 1”, “what are all the cameras belonging to the studio that support HD 5.1 and have a fiber connection”, etc. Queries may be nested with the result of one query used as the input to the next.

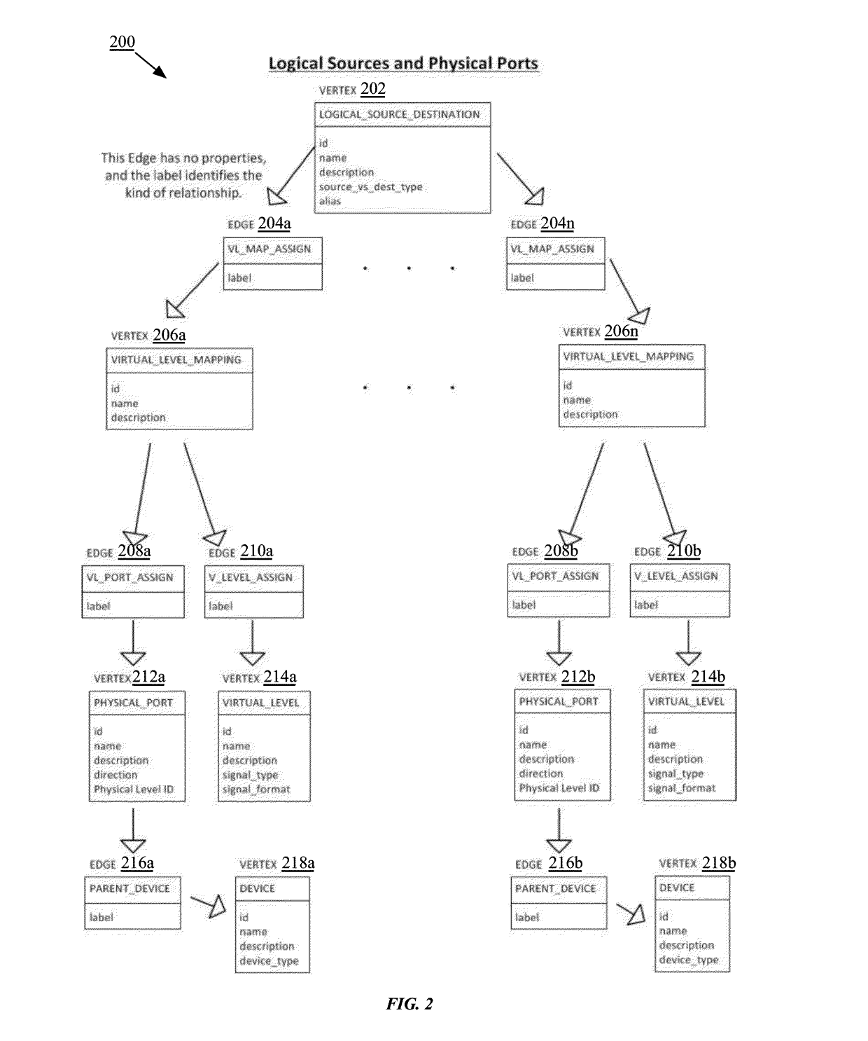

FIG. 2 is a schema diagram 200 illustrating nodes and edge connections within a graph-based model. As shown, a first vertex 202 may comprise a logical source or destination (e.g. a camera or playout server, or a recording server, transmitter, uplink, etc.). The source or destination vertex 202 may include or be associated with values for one or more of a unique identifier, name, description, or alias. The vertex 202 may include a flag, string, or other predetermined value to indicate whether the vertex is a source or destination.

As shown, the vertex 202 may connect to one or more other vertices 206a-206n via a corresponding one or more edges 204a-204n. In many implementations, edges 204a-204n (as well as edges 208a-208b, 210a-210b, and 216a-216b) may include labels to identify the kind of relationship between vertices, but may not include any other properties. In other implementations, edges may have further properties, such as unique identifiers, formats, types, directionality constraints, or any other type and form of properties.

In the example shown, a source or destination node 202 may be mapped to one or more virtual level mappings 206a-206n via corresponding edges 204a-204n. Virtual level mappings may represent specified input or output channels, such as an audio channel or video channel. As shown, each virtual level mapping 206a-206n may include or be associated with a unique identifier, name, description, or any other such information. A source or destination node 202 may be mapped to a plurality of virtual level mappings 206, allowing a user to switch multiple levels (and accordingly ports and/or signals) with a single button press.

Each virtual level mapping 206a-206n may be assigned to a physical port 212a-212b via a port assignment edge 208a-208b. As with other vertices, physical ports 212a-212b may be associated with a unique identifier, name, and description, or any other such information. In many implementations, physical ports 212a-212b may also be identified by direction (e.g. input or output), as well as a physical level identifier representing a physical format (e.g. fiber connector, XLR analog audio connector, BNC video connector, etc.). Similarly, each virtual level mapping 206a-206n may be assigned to a virtual level vertex 214a-214b via an assignment edge 210a-210b. In addition to a unique identifier, name, and/or description, each virtual level vertex 214a-214b may include or be associated with information about the mapped channel, such as a signal type, format, gain control, and/or any other type and form of channel- or format-related parameter. Furthermore, as shown, each physical port 212a-212b may be associated with a device 218a-218b via a parent device edge 216a-216b. The device vertex 218a-218b may include or be associated with a unique identifier, name, and/or description, and, in some implementations, a device type.

Accordingly, devices may be associated with ports, which may be associated with channel mappings and parameters, and may be identified as sources or destinations for a particular signal flow. Each node may inherit properties of connected nodes, accordingly creating a set of properties applicable to any signal flow.

Graphs, such as those illustrated in FIGS. 1A and 1B, may be generated by the system using any appropriate system or application for interpreting the underlying database model. For example, in one implementation, graphs may be generated in a GraphML format and visualized using any type and form of graph visualization tool.

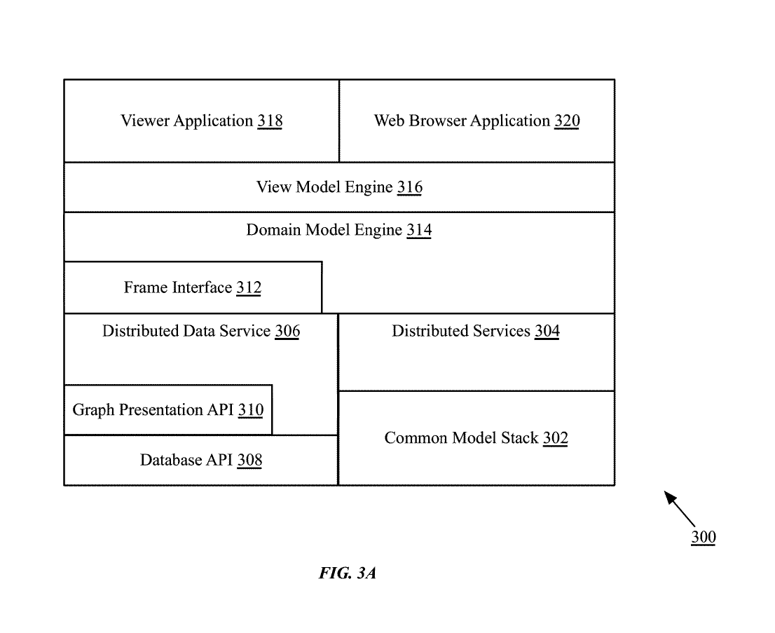

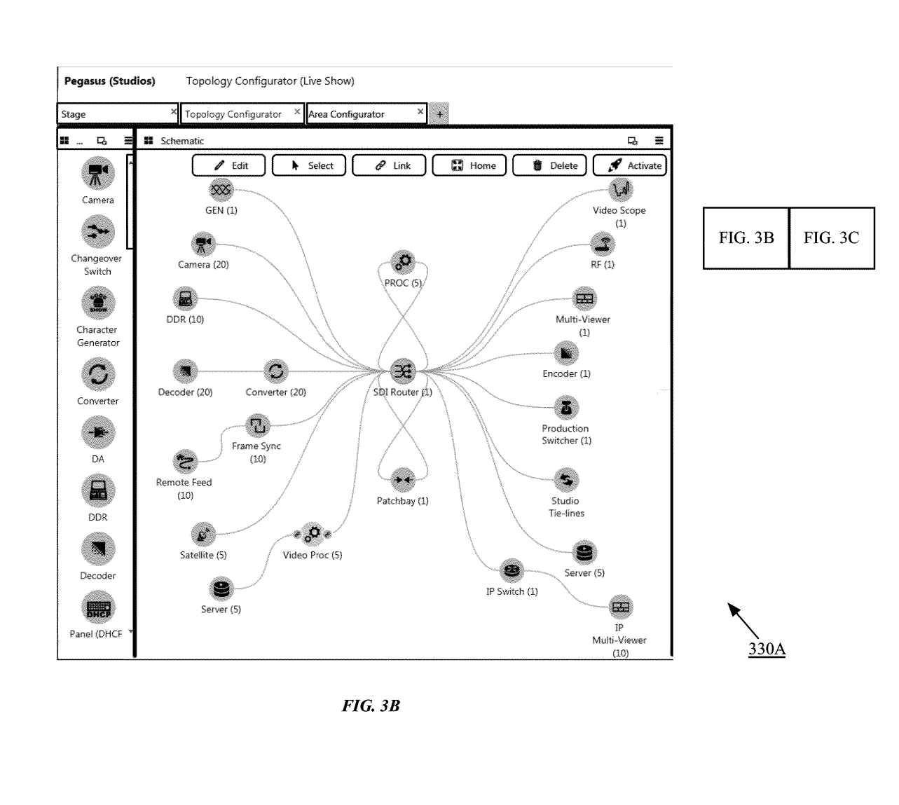

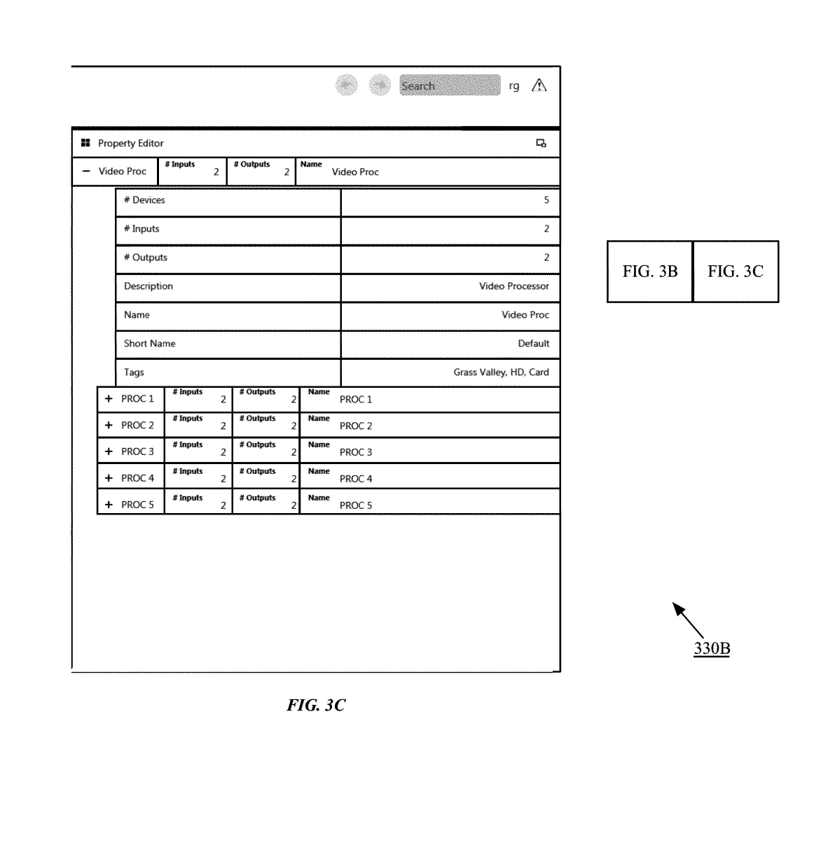

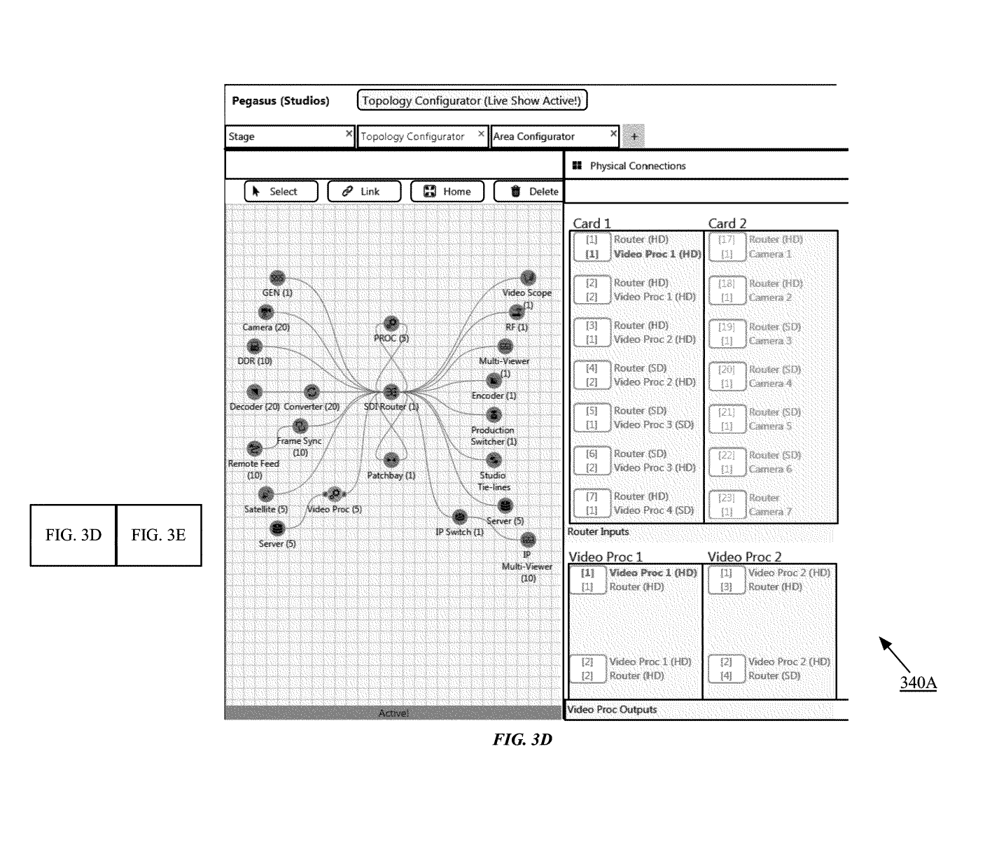

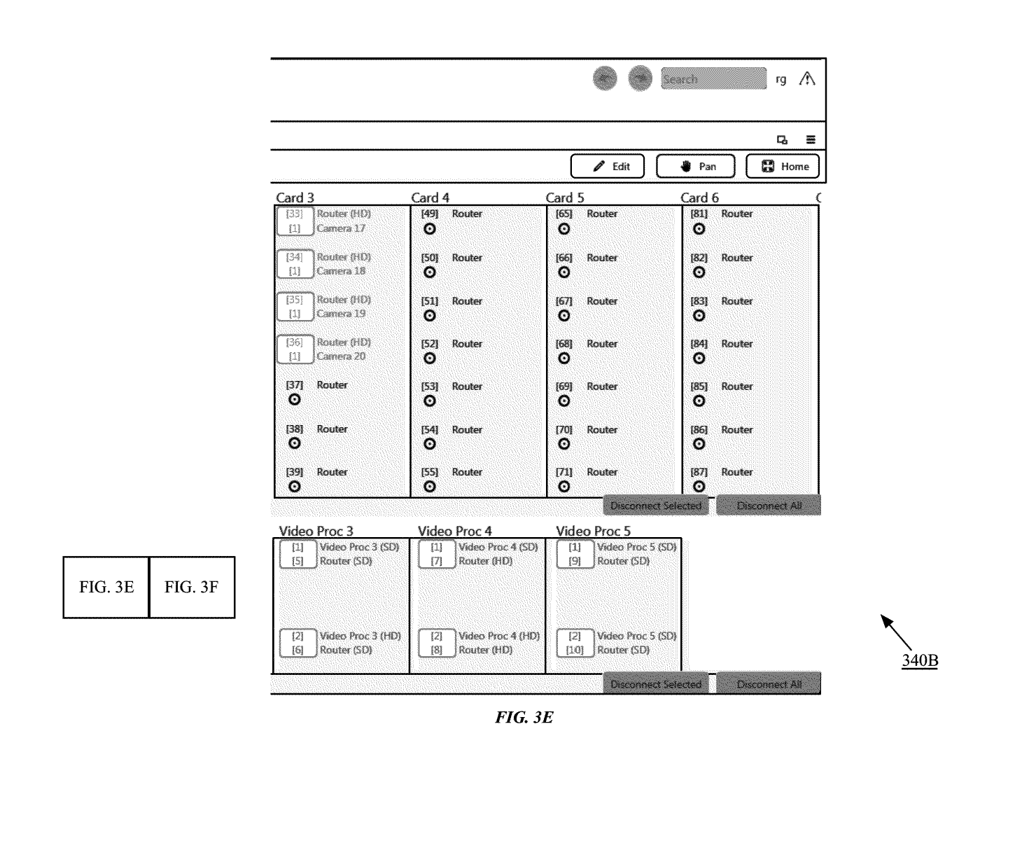

Referring now to FIG. 3A, illustrated is a block diagram of an exemplary system 300 for generating, analyzing, and maintaining graph-based models for broadcast environments, sometimes referred to as a management system, management agent, resource manager, or by any other similar terms. The illustrated system may be used by a client or server with only minor changes or by instantiating the system with different properties. A common core data model is used for both server side and client side operations. In brief overview, the system includes a common model stack 302 and distributed services module 304. The system also includes a distributed data service 306, which provides a database application programming interface (API) 308 and graph presentation API 310. The system further includes a frame interface 312, domain model engine 314, and view model engine 316. An application, such as a dedicated graph viewer and interaction application 318 or a web browser application 320, is used to interact with and view graph-based models. In many implementations, the system 300 may comprise a model view viewmodel (MVVM) architecture to separate the user interface from the model logic.

The domain model engine 314 is an application, service, server, routine, daemon, or other executable logic for accessing a database and creating a data object to be used by an application 318, 320. The domain model engine 314 provides an observable pattern to a view model engine 316, which may update a user interface, handle user interface events, and/or otherwise direct an application 318, 320 to update a visualized graph-model. Similarly, the view model engine 316 may comprise an application, server, service, routine, daemon, or other executable logic for rendering a user interface. The rendered user interface generated by the view model engine 316 may be in any type and format, such as a JavaFX format view or a HyperText Markup Language v5 (HTML5) format view.

In some implementations, the domain model engine 314 may implement interfaces for data configuration and control. For example, in one such implementation, a basic switching interface may be utilized for any device supporting a switch. A control panel may be provided to control any such device like a router. Other interfaces can be built on top of the switching interface so that common device control APIs can implement multiple interfaces for functions such as labeling signals, naming devices, locking switchers, etc. In some implementations, generic interfaces or generic device control interfaces may be used to discover parameters of the device that may be controlled. The domain model engine 314 may also provide dynamic monitoring via the user interfaces.

The view model engine 316 and domain model engine 314 may include a frame interface 312 or API for exposing a graph as a collection of interrelated domain objects. The frame interface 312 may provide a data schema to represent aspects of the graph model as objects and relationships for more intuitive control and analysis.

The system may include distributed services 304, such as one or more servers including web servers, remote desktop or virtualization services, or any other type and form of distributed services for providing access to the model to applications 318, 320. Similarly, a distributed data service 306 may provide one or more data servers for providing data, including the database underlying the graph model. A database API 308 and/or graph presentation API 310 may be provided for access and editing of the database by applications 318, 320 and/or view model engine 316 and domain model engine 314. Such APIs may be in any type and form, such as a representational state transfer (RESTful) interface or any other such interfaces.

As discussed above, graph models within the system may be very simple, with a collection of graphs, vertices, and edges, with properties that can be extensible from simple key-value pairs to more complex constructs including embedded documents, maps, tables, or other such data. All other domain models including devices, links, paths, sources, destinations, areas, may be derived from the vertices and edges within the graph models.

Graphs may be kept for history, with copies generated each time something changes within the signal path from source to destination. In some implementations, graphs may be kept for a period of weeks, months, or any other such duration. In one implementation, event vertices may be used for each temporal instance or configuration, with edge connections to vertices within said configurations. This allows a user to view the complete state of the signal path and recreate it within the user interface at any specified past time. Event vertices may also be used to allow a user to create virtual reconfigurations or “what if” scenarios that may be recalled and implemented quickly as needed.

The common model stack 302 may comprise an underlying architecture model for supporting specific entities and interfaces of the domain model engine 314 and view model engine 316. The common model stack 302 may comprise a database, data file, data access object, or other such data, and may define the fundamental classes representing vertices, edges, and graphs within the system.

As discussed above, the domain model engine 314 may provide functionality for performing queries and analyses on the graph-model. For example, the domain model engine 314 may allow for queries of constraints within the broadcast environment, such as whether a signal can be switched from a specified port of device A to a specified port of device B, responsive to available signal paths, formats, transcoders (if required), etc. In some implementations, queries of the database may be polymorphic, such as “get Device where . . . ” or “get Router where . . . ”, etc. In many implementations, partial results may be returned during complex searches, such as when historical data such as logs are searched. More recent information may be displayed first, and the querying user may cancel further searching when a desired result is found.

In some implementations, queries may use path finding and determination algorithms, including single transaction algorithms, such as a Bron-Kerbosch algorithm, a degree centrality based algorithm, an A-star search algorithm, a breadth-first search algorithm, a depth-first search algorithm, a shortest-path algorithm, a Bellman-Ford algorithm, a Dijkstra algorithm, or any other such algorithm; or distributed vertex-centric algorithms, such as a vertex-centric page rank algorithm, or any other type and form of algorithms. Such path finding queries may be used to identify alarms, troubleshoot failures, find lowest-latency paths for signal routing, identify potential loops, or perform any other such tasks. For example, in one such implementation, a user may request to switch a 720p video signal source to a 1080i signal destination. The system may use a path finding query to determine the shortest path between the source and destination that travels via an upscaling video processor having a 720p input and 1080i output. In some further implementations, the system may dynamically switch and reroute signals as necessary to free up signal paths or processors to perform a requested task. For example, if a first signal is flowing through a processor to a destination merely because it's part of a lowest-latency path, but does not require the resources of the processor, the system may re-route the first signal via a slightly longer path to free up the processor for upscaling a second signal.

Multiple versions of the graph-model and model engines may be running on a server simultaneously, either via one or more virtual machines or separate instances of the engine. This may provide a dynamic module system allowing reconfiguration of the broadcast environment without rebooting the system. For example, a server may include a plurality of media playout cards performing specific functions (e.g. SD-HD converters, mixers, routers, etc.). If an administrator wishes to install an additional playout card with a newer, incompatible version of the interface software, multiple instances of the model engines in different versions may be run simultaneously, allowing communication with each card or device without rebooting of the entire system or upgrading of legacy components.

FIGS. 3B and 3C are left and right halves, respectively, of an exemplary screenshot of a graph editing interface 330A-330B. As shown in FIG. 3B, a first portion of a user interface 330A, sometimes referred to as a topology configurator, may include a graph based schematic tool to model a system topology and interconnections. In some embodiments, users may drag and drop device groups, organized by categories, from a library or scrollable list into the graph, or may select from a list of manually entered or automatically discovered device groups. Device groups may include input and output ports, which may be uni-direction or bi-directional. For example, a serial digital interface may be uni-directional, while an Ethernet or Internet Protocol based interface may be bi-directional. New device types may be modeled by the user and the user may copy various properties from existing device types. Device types may be combined or split, in some implementations.

In a connection mode, compatible ports are displayed illustrating which devices in the graph may be interconnected. The user interface 330A may provide multiple ways to interconnect device groups. In a first method, a user may click (or tap, via a touch-based interface) on ports. In a second method, a user may click or touch and drag to connect two ports. In a third method, after entering a “connection” mode, the user may drag and touch nodes together to create a connection. This may be particularly useful when connecting many devices to another device, such as an SDI router or an IP switch.

Users may also configure device groups in bulk or individually using a property editor 330B, as shown in FIG. 3C. Device quantities may be specified in the schematic directly, such as via a spring or slider control. In other implementations, the user may interact with controls via a mouse/keyboard or touch/virtual keyboard.

FIGS. 3D and 3E are left and right halves, respectively, of another exemplary screenshot of a graph editing interface. Once devices are configured and interconnections are specified, the user may specify individual port connections using a physical connection user interface 340A-340B as shown in FIGS. 3D and 3E. The user interface 340A-340B may show the input and output ports of each device, responsive to user selection of a device. Filters may be used to search for and/or limit the ports displayed, such as port type filters (e.g. SDI or IP); statuses of ports (e.g. connected, unconnected, all); statuses of live signals (e.g. format, presence, errors); or any other type and form of information. Users may also navigate by panning and zooming or using a grid control to select to display a specific card and/or port. In some implementations, a search box may be provided so that users may search by ID number, device name, or any other such information.

In some implementations, the user may select multiple ports for interconnection via a control-click or shift-click, multi-touch interface, or other such interface. The user may also zoom in or out to display more or less information for any port. In some implementations, the user may navigate between devices in the graph or schematic (visible on the left in FIG. 3D) by clicking on the device, while in other implementations, the user may select a device by selecting a physical connection to the device from another device in the interface 340A-340B. In some implementations, the user may right-click, touch and hold, or otherwise select a device to set focus on the device, allowing further interaction without needing to specify the device. In some implementations, the user interfaces 330A-330B or 340A-340B may identify errors or rules violations, such as unconnected ports, too few devices, connection loops, frames without cards, or other such issues.

In a live mode, the user interfaces 330A-330B or 340A-340B may display operational views based on the status of the switching network in the system in real-time as signals are switched along the topology. For example, paths between nodes may be highlighted, colored, animated, and/or shaded to represent signal flow. As discussed above, in other implementations, the user interfaces 330A-330B or 340A-340B may be used to display historical system configurations, allowing visualization of past conditions that resulted in errors, for example.

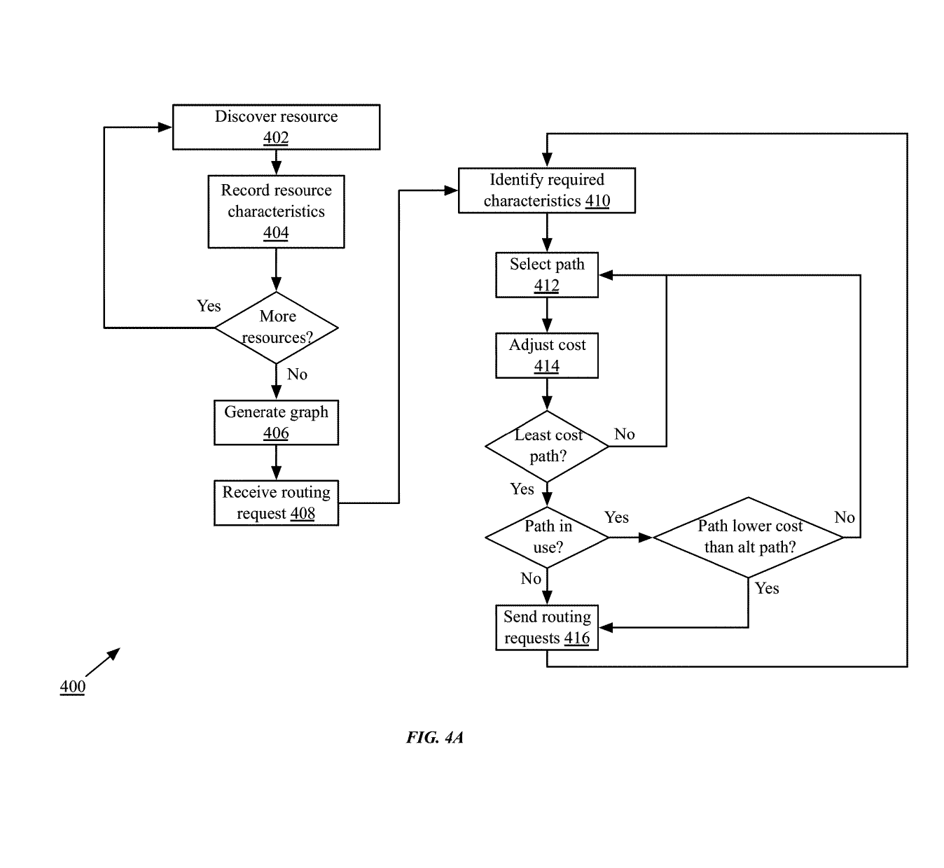

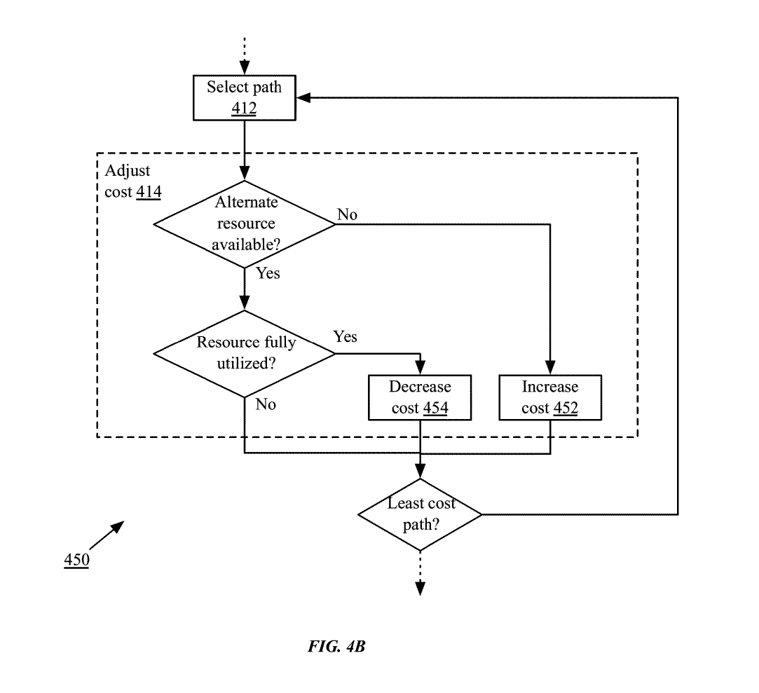

FIGS. 4A is a flow chart of an implementation of a method 400 of using graph modeling to manage, monitor, and control a broadcast environment. In brief overview, at step 402, in some implementations, a management server or agent may transmit a discovery signal or otherwise discover a broadcast resource in the environment. If a response is received, at step 404, the management agent may record characteristics of the resource. This may repeat until all resources have been identified. At step 406, the management agent may generate a graph model representative of the broadcast environment and its interconnections.

At step 408, the management agent may receive a routing request or request to connect or route a signal from a first broadcast device or resource to a second broadcast device or resource. At step 410, the management agent may identify the required characteristics to route the signal from the first resource to second resource.

At step 412, the management agent may select a path from the first broadcast resource to the second broadcast resource. At step 414, in some implementations, the management agent may identify and/or adjust a cost of the selected path. In some implementations, the management agent may determine if the path is a lowest or least cost path. If not, then steps 412-414 may be repeated. If the path is a least cost path, then the management agent may determine if the path is currently in use. If so, in some implementations, the management agent may determine whether the selected path has a lower cost for the first and second broadcast resource than a cost of the path for the resources currently using the path. If not, then steps 412-414 may be repeated for a next lowest cost path. At step 416, the path may be designated for use, and the management agent may send one or more routing or configuration requests to broadcast resources to initiate use of the path for routing the signal from the first broadcast resource to the second broadcast resource.

Still referring to FIG. 4A and in more detail, at step 402, in some implementations, a management server or agent may transmit a discovery signal or otherwise discover a broadcast resource in the environment. In some implementations in which resources are connected via an IP network, discovering a resource may comprise transmitting or broadcasting a discovery packet or similar request via the network. In other implementations, a subset of resources within the system may be queried, such as IP switches or routers or audio or video routers that may have information about sources and/or destinations connected to each switch or router. For example, a router may be pre-programmed with identifications of connected resources, and may be queried to retrieve these identifications. In a similar implementation, a router may identify connected signal sources and destinations by type (e.g. HDMI, balanced analog audio, AES/EBU digital audio, etc. In still other implementations, an auto-discovery process may be performed by commanding switch resources under control of the management agent to make various connections, and determining whether valid signals are passed via the switch. For example, a switch may be commanded to connect a first output to a first input, and report whether a valid audio or video signal is provided via the connection. Each input may be successively connected to each output or vice versa in order to probe the capabilities of each resource. In still other implementations, an administrator or engineer may enter identifications of each broadcast resource and/or their characteristics manually. In some implementations, the management agent may provide a user interface, as discussed above, for allowing an administrator to add resources and configure their characteristics.

In implementations using a discovery packet, signal, or procedure, a response may be received, the response comprising information about a resource and/or its characteristics, such as a device identifier or name, device type, number and type of inputs (e.g. digital video, digital audio, analog audio, HDMI, H.264, IEEE 1394, etc.), number and type of outputs, processing ability (e.g. frame resynchronization, audio or video encoding or decoding, multiplexing or demultiplexing, mixing, equalization, surround sound encoding, transcoding or conversion, upscaling or downscaling, etc.), latency from input to output (with and/or without processing applied), or any other such characteristics. In other implementations, the characteristics may be retrieved from a router or switch or other device, or may be entered manually by an administrator or engineer. At step 404, the management agent may record characteristics of the resource. The characteristics may be recorded in a database, data table, index, flat file, or any other type and form of data structure, such as the data structures discussed above in connection with FIG. 2. Steps 402-404 may repeat until all resources have been identified. At step 406, the management agent may generate a graph model representative of the broadcast environment and its interconnections. The graph model may be generated via a graphing API as discussed above, and may be presented to a user or administrator via a user interface, as discussed above. Nodes or vertices of the graph model may represent broadcast resources (e.g. sources, destinations, routers, processors, etc.), and edges may represent physical interconnections between resources. In some implementations, each edge may have one or more characteristics, such as a type of signal capable of being carried by the edge (e.g. balanced analog audio, digital video, etc.) as well as a length, latency, or any other such information.

As discussed above, the graph may be used to identify signal routing possibilities and provide path-based routing and management. At step 408, in some implementations, the management agent may receive a routing request or request to connect or route a signal from a first broadcast device or resource to a second broadcast device or resource. For example, the request may be to route a signal from a camera to a recording device, or from a satellite receiver to a multiviewer. The request may be provided by a user or operator, by an administrator, by an automation system, or any other such entity. In some implementations, the request may be made via a user interface of the management agent, while in other implementations, the request may be received via a network interface or API call from another application.

At step 410, the management agent may identify the required characteristics to route the signal from the first resource to second resource. As discussed above, the first broadcast resource and second broadcast resource may have various characteristics, which may or may not be complementary. For example, if the first resource has an unbalanced analog output and the second resource has an unbalanced analog input, the signal may be easily routed from the first resource to the second resource via a path identified at step 412 (provided sufficient routers or interconnections exist). However, if the first resource has 8 channels of unbalanced audio outputs and the second resource has a multichannel AES10 input via optical fiber, the two characteristics are not complementary. Instead, the management agent may identify another resource or resources having complementary inputs and outputs such that the signal may be provided from the first resource to the second resource via the other resources performing any necessary signal conversions. For example, the management agent may identify a resource having analog to digital audio converters. Similarly, another implementation, a first resource may output a 720p60 format video and a second resource may receive a 1080i30 format video as an input. The management agent may accordingly identify a video converter capable of up-scaling and reducing the frame rate.

In some implementations, if a single resource cannot be identified having input and output characteristics corresponding to the first resource and second resource, at step 412, the management agent may iteratively search the graph for pairs of resources that together have input and output characteristics corresponding to the first resource and second resource, as well as complementary characteristics between them. In one such implementation, with a first resource outputting a signal in a first format and second resource inputting a signal in a second format, the management agent may identify a set of resources having an input capable of receiving a signal in the first format. From the identified set, the management agent may determine if any of the resources have an output capable of providing a signal in the second format. If so, such a resource may be used as an intermediary to the first and second resources. If not, in one implementation, the management agent may identify a second set of resources having an output capable of providing a signal in the second format. The management agent may compare the first set and second set of resources to find a pair of resources capable of communicating a signal via a third format. The pair may then be used as an intermediary to the first and second resource. This process may be iteratively repeated, if necessary, by selecting a pair of resources from the first set and second set of identified resources and identifying further sets of intermediary resources, as if the selected pair were the first and second resource. For example, given a source A and destination Z, the management agent may identify an intermediary B capable of receiving the signal from source A and an intermediary Y capable of providing a signal to destination Z. If intermediaries B and Y do not share a common signal characteristic, then the management agent may identify an intermediary C capable of receiving the signal from B and an intermediary X capable of providing a signal to Y. This may be repeated for different pairs of resources B and Y or for different iterations of intermediary pairs until a complete signal path may be identified from the first resource to the second resource. The path may be selected at step 412 as a potential signal flow path from the first resource to the second resource.

In many implementations, many potential signal flow paths exist in a broadcast environment, via different intermediary resources, switchers, etc. For example, a first path may be directly from the first resource to the second resource. A second path may be via a third resource, such as a switcher. A third path may be via a fourth resource such as an encoder and a fifth resource, such as a decoder. A signal may potentially be routed via any combination of resources within the environment. However, each path may have different costs associated with it, and accordingly, the paths may be ranked from most desirable or efficient to least desirable or efficient. In one such implementation, a cost may be determined for each path based on path length, such as the number of vertices and edges (or resources and interconnections) traversed by the path. In such implementations, a shortest path first algorithm may be used to select potential paths, such as Dijkstra's algorithm, with paths removed once utilized by other resources. In another such implementation, a cost may be determined for each path based on a total latency of the path. Each resource and interconnection traversed along the path may add a small amount of latency, frequently on the order of milliseconds in many broadcast environments. As more resources are traversed, the latency may approach or exceed entire frames of video, potentially resulting in lip synchronization errors or requiring separate delaying and resynchronization of other signals. In still another implementation, a path cost may be determined based on whether alternate resources having the same capabilities are available or if capabilities of an intermediary device are underutilized by the path. For example, as discussed above, in some implementations, intermediary devices or resources may be utilized to convert from a first signal format to a second signal format. Such intermediary devices typically have other, additional functions or processing capabilities that may be utilized, and accordingly, a cost calculation for a path may be increased if the path does not utilize those features. For example, many digital audio recording devices are capable of receiving an analog input and providing a digital output. While these devices may be used in a pass-through mode as simple analog-to-digital converters, this does not utilize the audio recording and playback capabilities of the device. Accordingly, a path via such a resource may be deemed more costly than one via a simple analog-to-digital converter that has no other functions. This allows the management agent to automatically select intermediary resources to keep additional functionality available until no other options are available. Likewise, in some implementations, a cost for a path via a last resource of a specified type may be more expensive. For example, given three potential intermediary resources with the ability to convert from one signal type to another in addition to other processing functions, and two of the resources are of the same type (e.g. recorders, equalizers, etc.), the management agent may increase the cost for using the third resource, or otherwise select one of the two identical resources to maintain flexibility for subsequent routing requests.

Accordingly, at step 414, in some implementations, the management agent may identify and/or adjust a cost of the selected path. Referring briefly to FIG. 4B, illustrated is one implementation of a method 450 for adjusting the cost of a path at step 414. Once a path is selected at 412, the system may determine if alternate resources are available having the same functionality. If not, at step 452, the cost for the path or the resource within the path may be increased by a predetermined amount. The management agent may also determine if the resource is fully utilized, or if functions of the resource will be utilized during signal flow along the path (e.g. encoding or decoding functions, recording functions, etc.). If so, the cost for the path or the resource may be decreased at step 454 by a predetermined amount. In other implementations, other similar cost manipulations may be applied based on usage, redundancy, load balancing, or other features.

Returning to FIG. 4A, in some implementations, the management agent may determine if the path is a lowest or least cost path. Various shortest path or graph search algorithms may be used in different implementations, including Dijkstra's algorithm, a Bellman-Ford algorithm, a backtracking algorithm, or any other similar algorithm for graph traversal via weights or costs for vertices and edges. In some implementations, to determine a lowest cost path, a plurality of paths may be identified, adjusted if necessary at step 414, and compared until a least cost path is identified. As discussed above, the cost may be based on the number of resources or nodes traversed, the total latency, the uniqueness of functionality or unused functionality of path nodes, or any other such characteristics.

If the path is a least cost path, then in some implementations, the management agent may determine if the path or a portion of the path is currently in use for another signal flow or routing. If so, in some implementations, the management agent may determine whether the selected path has a lower cost for the first and second broadcast resource than a cost of the path for the resources currently using the path. For example, if a selected path is already in use for routing a signal between another pair of resources, but, for those resources, the path has a higher cost (e.g. the other pair of resources do not use all of the functionality of an intermediary resource, the path is longer for the other pair of resources than for the first and second broadcast resource, etc.), then in some implementations, the management agent may switch the use of the path to the first and second broadcast resources, and select a new path for the other pair of resources. This allows the management agent to dynamically adjust to changing conditions and find optimal routing configurations. In a further implementation, the management agent may determine if a cost difference between the selected path and an alternate path for the first and second broadcast resource is larger than a cost difference between the selected path and an alternate path for the other pair of resources, and switch the use of the path responsive to the determination. Conversely, in some implementations, if the additional cost of using a less efficient or longer path for the first and second broadcast resource is less than the additional cost of using an alternate path for the other pair of resources, then the management agent may determine that the first and second broadcast resource should use an alternate path.

At step 416, once a path is selected and confirmed as available, the management agent may send one or more routing or configuration requests to broadcast resources to initiate use of the path for routing the signal from the first broadcast resource to the second broadcast resource. Sending the routing or configuration requests may include transmitting commands to one or more routing switchers, IP switches, or other switching entities, and/or transmitting configuration commands to one or more resources (e.g. to select an input or output format, perform transcoding, etc.).

Accordingly, via the systems and methods discussed herein, a broadcast environment may be mapped via a graph model and managed with routing functionality dynamically determined based on weighted edge and vertex search algorithms. The system can provide automatic rerouting in case of failure, optimization and load balancing, and fulfill complex routing requirements with multiple levels of intermediary transcoding.

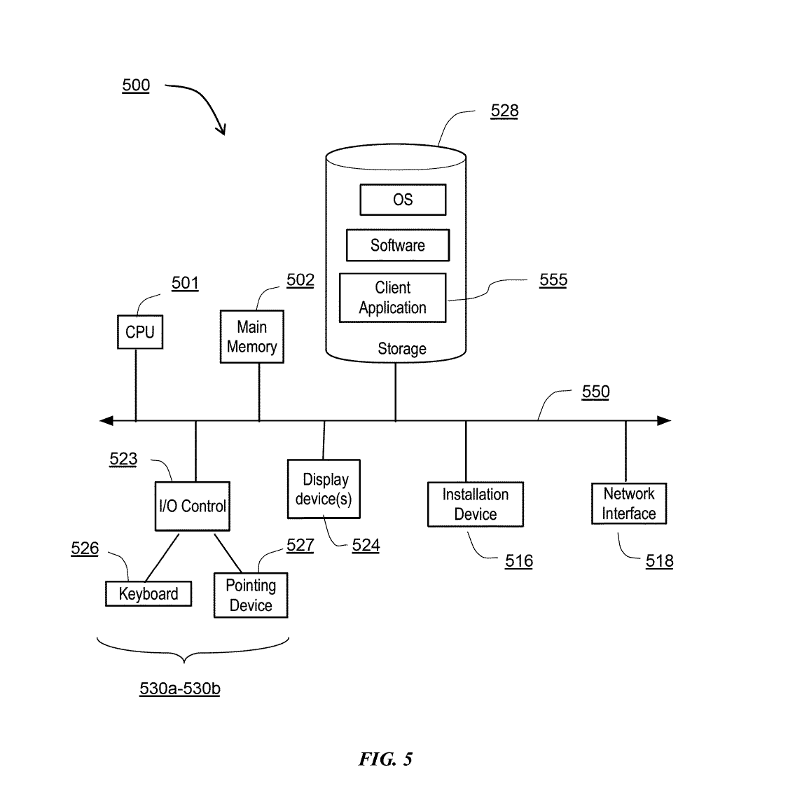

As discussed above, the system may be maintained or executed on various computing devices, including servers, workstations, desktop or laptop computers, virtual servers or cloud servers, or any other type and form of computing device. FIG. 5 is a block diagram of an exemplary computing device useful for practicing the methods and systems described herein. The computing device 500 may comprise a laptop computer, desktop computer, virtual machine executed by a physical computer, tablet computer, such as an iPad tablet manufactured by Apple Inc. or Android-based tablet such as those manufactured by Samsung, Inc. or Motorola, Inc., smart phone or PDA such as an iPhone-brand/iOS-based smart phone manufactured by Apple Inc., Android-based smart phone such as a Samsung Galaxy or HTC Droid smart phone, or any other type and form of computing device. A computing device 500 may include a central processing unit 501; a main memory unit 502; a visual display device 524; one or more input/output devices 530a-430b (generally referred to using reference numeral 530), such as a keyboard 526, which may be a virtual keyboard or a physical keyboard, and/or a pointing device 527, such as a mouse, touchpad, or capacitive or resistive single- or multi-touch input device; and a cache memory 540 in communication with the central processing unit 501.

The central processing unit 501 is any logic circuitry that responds to and processes instructions fetched from the main memory unit 502 and/or storage 528. The central processing unit may be provided by a microprocessor unit, such as: those manufactured by Intel Corporation of Santa Clara, Calif.; those manufactured by Motorola Corporation of Schaumburg, Ill.; those manufactured by Apple Inc. of Cupertino Calif., or any other single- or multi-core processor, or any other processor capable of operating as described herein, or a combination of two or more single- or multi-core processors. Main memory unit 502 may be one or more memory chips capable of storing data and allowing any storage location to be directly accessed by the microprocessor 501, such as random access memory (RAM) of any type. In some embodiments, main memory unit 502 may include cache memory or other types of memory.

The computing device 500 may support any suitable installation device 516, such as a floppy disk drive, a CD-ROM drive, a CD-R/RW drive, a DVD-ROM drive, tape drives of various formats, USB/Flash devices, a hard-drive or any other device suitable for installing software and programs such as any client application 555, or portion thereof. The computing device 500 may further comprise a storage device 528, such as one or more hard disk drives or redundant arrays of independent disks, for storing an operating system and other related software, and for storing application software programs such as any program related to the client application 555. Client application 555 may comprise a web browser, application, or other interface for accessing a user interface provided by the media distribution and management system as discussed above.

Furthermore, the computing device 500 may include a network interface 518 to interface to a Local Area Network (LAN), Wide Area Network (WAN) or the Internet through a variety of connections including, but not limited to, standard telephone lines, LAN or WAN links (e.g., Ethernet, T1, T3, 56kb, X.25), broadband connections (e.g., ISDN, Frame Relay, ATM), wireless connections, (802.11a/b/g/n/ac, BlueTooth), cellular connections, or some combination of any or all of the above. The network interface 518 may comprise a built-in network adapter, network interface card, PCMCIA network card, card bus network adapter, wireless network adapter, USB network adapter, cellular modem or any other device suitable for interfacing the computing device 500 to any type of network capable of communication and performing the operations described herein.

A wide variety of I/O devices 530a-430n may be present in the computing device 500. Input devices include keyboards, mice, trackpads, trackballs, microphones, drawing tablets, and single- or multi-touch screens. Output devices include video displays, speakers, headphones, inkjet printers, laser printers, and dye-sublimation printers. The I/O devices 530 may be controlled by an I/O controller 523 as shown in FIG. 5. The I/O controller may control one or more I/O devices such as a keyboard 526 and a pointing device 527, e.g., a mouse, optical pen, or multi-touch screen. Furthermore, an I/O device may also provide storage 528 and/or an installation medium 516 for the computing device 500. The computing device 500 may provide USB connections to receive handheld USB storage devices such as the USB Flash Drive line of devices manufactured by Twintech Industry, Inc. of Los Alamitos, Calif.

The computing device 500 may comprise or be connected to multiple display devices 524a-424n, which each may be of the same or different type and/or form. As such, any of the I/O devices 530a-430n and/or the I/O controller 523 may comprise any type and/or form of suitable hardware, software embodied on a tangible medium, or combination of hardware and software to support, enable or provide for the connection and use of multiple display devices 524a-424n by the computing device 500. For example, the computing device 500 may include any type and/or form of video adapter, video card, driver, and/or library to interface, communicate, connect or otherwise use the display devices 524a-424n. A video adapter may comprise multiple connectors to interface to multiple display devices 524a-424n. The computing device 500 may include multiple video adapters, with each video adapter connected to one or more of the display devices 524a-424n. Any portion of the operating system of the computing device 500 may be configured for using multiple displays 524a-424n. Additionally, one or more of the display devices 524a-424n may be provided by one or more other computing devices, such as computing devices 500a and 500b connected to the computing device 500, for example, via a network. These embodiments may include any type of software embodied on a tangible medium designed and constructed to use another computer's display device as a second display device 524a for the computing device 500. One ordinarily skilled in the art will recognize and appreciate the various ways and embodiments that a computing device 500 may be configured to have multiple display devices 524a-424n. The various components may be connected via a local communication bus 540, which may comprise any type and form of intermodule or inter-component communication bus, including USB, PCIe, or any other such bus.

A computing device 500 of the sort depicted in FIG. 5 typically operates under the control of an operating system, such as any of the versions of the Microsoft® Windows operating systems, the different releases of the Unix and Linux operating systems, any version of the Mac OS® for Macintosh computers, any embedded operating system, any real- time operating system, any open source operating system, any proprietary operating system, any operating systems for mobile computing devices, or any other operating system capable of running on the computing device and performing the operations described herein.

The computing device 500 may have different processors, operating systems, and input devices consistent with the device. For example, in one embodiment, the computer 500 is an Apple iPhone or Motorola Droid smart phone, or an Apple iPad or Samsung Galaxy Tab tablet computer, incorporating multi-input touch screens. Moreover, the computing device 500 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software embodied on a tangible medium, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, floppy disk, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

The system may also be delivered as a cloud-based or network-based service, or as a hosted application or under a Software-as-a-Service (SaaS) or Platform-as-a-Service (PaaS) delivery model, and accordingly may execute on one or more computing devices or servers, and/or one or more virtual servers or virtual machines executed by one or more computing devices. In some such implementations, the system may comprise one or more load balancers, access control servers, or other such devices for deploying and providing services to remote devices.

What is claimed:

1. A method of managing broadcast resources via a graph-based model, comprising:
identifying, by a management system of a broadcast environment, characteristics of each of a plurality of broadcast resources, the characteristics including at least an input or output;
generating, by the management system, a graph-based model of the plurality of broadcast resources based on the identified characteristics;
receiving, by the management system, a request to route a signal from a first broadcast resource of the plurality of broadcast resources to a second broadcast resource of the plurality of resource;
selecting, by the management system, a path from the first broadcast resource to the second broadcast resource via at least one additional broadcast resource, based on the identified characteristics of each of the plurality of broadcast resources; and
commanding, by the management system, the first broadcast resource, second broadcast resource, and at least one additional broadcast resource to send and receive signals along the selected path.

2. The method of claim 1, wherein the characteristics further include at least one input signal type and at least one output signal type.

3. The method of claim 2, wherein the first broadcast resource has a first signal type, the second broadcast resource has a second signal type, and wherein selecting the path from the first broadcast resource to the second broadcast resource further comprises selecting a path via a third broadcast resource having an input signal type of the first signal type and an output signal type of the second signal type.

4. The method of claim 1, wherein selecting the path from the first broadcast resource to the second broadcast resource further comprises identifying a shortest path via the graph-based model.

5. The method of claim 4, wherein identifying the shortest path via the graph-based model further comprises identifying a path from the first broadcast resource to the second broadcast resource via a fewest number of intermediary nodes of the graph, each node representing a broadcast resource.

6. The method of claim 4, wherein identifying the shortest path via the graph-based model further comprises identifying a path from the first broadcast resource to the second broadcast resource having a lowest total latency, each broadcast resource of the graph having an associated processing latency.

7. The method of claim 1, wherein the selected path from the first broadcast resource to the second broadcast resource is via a third broadcast resource; and further comprising:
receiving, by the management system, a request to route a signal from a fourth broadcast resource to a fifth broadcast resource;
selecting, by the management system, a path from the fourth broadcast resource to the fifth broadcast resource via the third broadcast resource;
determining, by the management system, the third broadcast resource is unable to simultaneously carry the path between the first and second broadcast resources and the path between the fourth and fifth broadcast resources;
selecting, by the management system, a second path from the first broadcast resource to the second broadcast resource via a sixth broadcast resource; and
commanding the first broadcast resource, second broadcast resource, and sixth broadcast resource to send and receive signals along the second path.

8. The method of claim 7, wherein selecting the second path from the first broadcast resource to the second broadcast resource via the sixth broadcast resource further comprises:
identifying a first cost of the path from the first broadcast resource to the second broadcast resource via the third broadcast resource;
identifying a second cost of the path from the fourth broadcast resource to the fifth broadcast resource via the third broadcast resource;
determining that the first cost exceeds the second cost; and
selecting the second path, responsive to the determination that the first cost exceeds the second cost.

9. The method of claim 8, further comprising:
identifying a third cost of the path from the first broadcast resource to the second broadcast resource via the sixth broadcast resource;
identifying a fourth cost of a path from the fourth broadcast resource to the fifth broadcast resource via a seventh broadcast resource;
determining that the third cost is less than the fourth cost; and
wherein selecting the second path is further performed responsive to the determination that the third cost is less than the fourth cost.

10. The method of claim 9, further comprising:
determining that a difference between the third cost and first cost is less than a difference between the fourth cost and second cost; and
wherein selecting the second path is further performed responsive to the determination that the difference between the third cost and first cost is less than the difference between the fourth cost and second cost.

11. The method of claim 8, wherein identifying a first cost of the path from the first broadcast resource to the second broadcast resource via the third broadcast resource further comprises identifying a total length of the path, a total latency of the path, a number of resources traversed by the path, a number of unique resources traversed by the path, or a number of alternate paths available.

12. A system for managing broadcast resources via a graph-based model, comprising:
a processor executing a management agent in communication with at least one of a plurality of broadcast resources via a network interface of the system, the management agent configured to:
identify characteristics of each of a plurality of broadcast resources, the characteristics including at least an input or output,
generate a graph-based model of the plurality of broadcast resources based on the identified characteristics,
receive a request to route a signal from a first broadcast resource of the plurality of broadcast resources to a second broadcast resource of the plurality of resource,
select a path from the first broadcast resource to the second broadcast resource via at least one additional broadcast resource, based on the identified characteristics of each of the plurality of broadcast resources, and
command the first broadcast resource, second broadcast resource, and at least one additional broadcast resource to send and receive signals along the selected path.

13. The system of claim 12, wherein the characteristics identify an input signal type and an output signal type, the first broadcast resource has a first signal type, the second broadcast resource has a second signal type, and wherein the management agent is further configured to select a path via a third broadcast resource having an input signal type of the first signal type and an output signal type of the second signal type.

14. The system of claim 12, wherein the management agent is further configured to identify a shortest path via the graph-based model, and select the shortest path as the path from the first broadcast resource to the second broadcast resource.

15. The system of claim 14, wherein the management agent is further configured to identify a path from the first broadcast resource to the second broadcast resource via a fewest number of intermediary nodes of the graph, each node representing a broadcast resource, or having a lowest latency.

16. The system of claim 12, wherein the selected path from the first broadcast resource to the second broadcast resource is via a third broadcast resource; and
wherein the management agent is further configured to:
select a second path from the first broadcast resource to the second broadcast resource via a fourth broadcast resource, responsive to a determination to use the third broadcast resource for a third path between additional broadcast resources, and
command the first broadcast resource, second broadcast resource, and fourth broadcast resource to send and receive signals along the second path.

17. The system of claim 16, wherein the management agent is further configured to identify a first cost of the path from the first broadcast resource to the second broadcast resource via the third broadcast resource, and select the second path responsive to the first cost exceeding a cost of the third path.

18. The system of claim 17, wherein the management agent is further configured to increase the first cost responsive to the first broadcast resource and second broadcast resource less than all of the functions of the third broadcast resource.

19. The system of claim 17, wherein the management agent is further configured to identify the first cost based on a total length of the path or a total latency of the path.

20. The system of claim 17, wherein the management agent is further configured to identify the first cost based on a number of resources traversed by the path, a number of unique resources traversed by the path, or a number of alternate paths available.
